(19) United States
(12) Patent Application Publication
(10) Pub. No.: US 2026/0301262 A1
(43) Pub. Date: Oct. 1, 2026

(54) METHOD FOR IMAGE DATA AUGMENTATION, METHOD FOR TRAINING MODEL USING AUGMENTED IMAGE DATA AND NON-TRANSITORY COMPUTER-READABLE MEDIUM

(71) Applicant: LITE-ON TECHNOLOGY CORPORATION, TAIPEI CITY (TW)

(72) Inventors: KUN-DA LIN, TAIPEI CITY (TW); TSUNG-HUNG TSAI, TAIPEI CITY (TW); Tse-Chun Wang, TAIPEI CITY (TW)

(21) Appl. No.: 19/408,293

(22) Filed: Dec. 3, 2025

Related U.S. Application Data
(60) Provisional application No. 63/776,989, filed on Mar. 25, 2025.

(30) Foreign Application Priority Data
Aug. 18, 2025 (CN) 202511152733.1

(51) Int. Cl. G06T 11/60; G06T 7/174

(52) U.S. Cl. CPC G06T 11/60; G06T 7/174; G06T 2207/20081; G06T 2207/20084; G06T 2207/20132

(57) ABSTRACT

A method for image data augmentation, a method for training model using augmented image data and a non-transitory computer-readable medium. In the method for image data augmentation, multiple images are firstly obtained, and a data augmentation procedure is performed on each of the multiple images. In the data augmentation procedure, each of the multiple images is cropped into a first size image, and the first size image is modified to be a second size image. The second size image is randomly cropped at different positions into multiple image blocks for multiple times. The multiple image blocks are then randomly arranged and recombined into an augmented image. After repeatedly performing the data augmentation procedure on the multiple images, multiple augmented images that are configured to be a training dataset to train an intelligent model are generated.

### CROSS-REFERENCE TO RELATED PATENT APPLICATION

This application claims the benefit of priority to China Patent Application No. 202511152733.1, filed on Aug. 18, 2025, in the People’s Republic of China. The entire content of the above identified application is incorporated herein by reference.

This application claims the benefit of priority to the U.S. Provisional Patent Application Ser. No. 63/776989, filed on March 25, 2025, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a data augmentation technology, and more particularly to a method for image data augmentation by recombining images that are randomly adjusted, a method for training a model using augmented image data, and a non-transitory computer-readable medium.

### BACKGROUND OF THE DISCLOSURE

The data used to train an artificial intelligence (AI) model affects performance and generalization of a trained model. If the training data is not diverse enough, e.g., the data can either lack variation, be too stable, or come from a source that is too simple, which may cause overfitting (fitting) to occur in the trained model, resulting in degraded performance when handling complex applications. Therefore, for training a machine-learning model, a data augmentation technology is provided for generating new data on the collected data through additional steps. In general, a large amount of sufficient and diverse training data is required in an initial stage of training the machine-learning model. However, in fact, the data being collected may be too simplistic due to various limitations. The data augmentation technology can effectively increase diversity of the training data by modifying the original data.

One of the conventional data augmentation technologies is such as a random shuffle patch method referring to a flow diagram shown in FIG. 1. In the random shuffle patch method, a collected original image 11 is firstly divided into multiple image blocks 13, and the multiple image blocks 13 are then randomly shuffled and recombined to form a new image. As shown in the diagram, a first recombined image 15 and a second recombined image 16 that are randomly shuffled from the original image 11 are formed. Lastly, a first augmented image 17 and a second augmented image 18 are respectively formed. The above-described process can be used to increase diversity of the training data, so that generalization and accuracy of the machine-learning model that is trained by the training data undergoing data augmentation can be enhanced.

For example, instead of relying solely on standard human facial images, images not limited to complete facial structures are required to train a face recognition model with high accuracy. The above-mentioned random shuffle patch method is therefore provided for dividing the human facial images into multiple image blocks, randomly shuffling and recombining the multiple image blocks, so that the diversity of the data can be enhanced. Therefore, the robustness of the model that is trained by the above data can be enhanced.

### SUMMARY OF THE DISCLOSURE

In response to the above-referenced technical inadequacies, the present disclosure provides a method for image data augmentation, a method for training model using augmented image data and a non-transitory computer-readable medium. One of the objectives of the method for image data augmentation is to augment diversity of the data used for training a machine-learning model, so that the intelligent model trained by augmented image data achieves generalization capabilities.

In an aspect, the method for image data augmentation is performed in a computer system, in the method, a data augmentation procedure is performed on each of received multiple images. In the data augmentation procedure, each of the multiple images is randomly cropped from different positions multiple times to obtain multiple image blocks with random sizes. Next, each of the multiple image blocks is resized and then the multiple resized image blocks are randomly arranged and recombined to be an augmented image. Thus, after repeatedly performing the data augmentation procedure, multiple augmented images can be generated from the original multiple images to form a training set for training the intelligent model.

It should be noted that each of the multiple images is cropped to be a first size image that has an aspect ratio different from an original aspect ratio of each of the received multiple images.

In another aspect of the data augmentation procedure, a length and a width of the first size image are adjusted in different ratios and then an area of the first size image with an adjusted aspect ratio can be adjusted to form a second size image.

In one further aspect, the length and the width of the first size image can be adjusted in different ratios, and an area of the first size image with a modified aspect ratio can be further adjusted. After that, the first size image is cropped to be a second size image with a smaller area. The second size image can be used as one of the images in the data augmentation procedure.

Further, the data augmentation procedure includes color jitter and blur processing to be performed on any of the multiple images.

Still further, the second size images can be used to obtain the augmented image by recombining the image blocks with the same size or different sizes that are arranged in a “m×n” array, in which m and n are the same integer or different integers greater than 1.

Further, in the data augmentation procedure, each of the multiple images is randomly cropped at different positions and with random sizes multiple times to form multiple image blocks.

The above-formed multiple augmented images are used as a training set for training an intelligent model through a deep-learning algorithm.

Further, when using the multiple augmented images to form the training set for training the intelligent model, a mix style can be applied to a middle layer of the intelligent model for processing feature-layer style mixing.

Multiple labels can be assigned to the multiple augmented images based on image features of the augmented images. A label smoothing process can be performed on the multiple labels for preventing overfitting when training the intelligent model.

Further, a loss function can be used to assess prediction results and distances among the multiple labels of the intelligent model being trained. A backpropagation algorithm is used to calculate gradients of the loss function, and the loss function can be minimized by updating the weight values of the intelligent model.

In an aspect of the non-transitory computer-readable medium, the non-transitory computer-readable medium stores an instruction set including a first set of program codes, and the instruction set is performed by one or more processors of a computer system for implementing the method for image data augmentation.

Further, the instruction set includes a second set of program codes that is performed by the one or more processors to implement the method for a training model using augmented image data.

In an aspect, the multiple images used to train the intelligent model are multiple human facial images. The trained intelligent model can be used to identify a live face or a spoofed face through multiple human facial images.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram illustrating a flow of a conventional process of randomly shuffling image blocks;

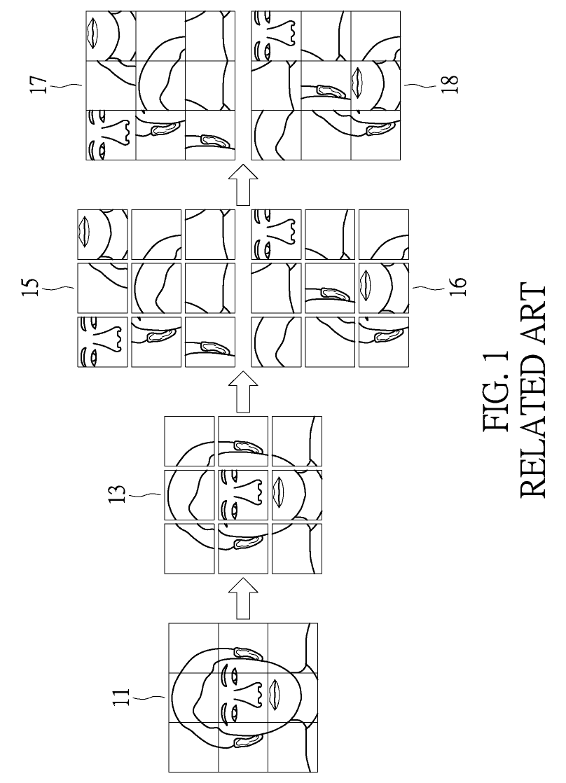

FIG. 2 is a schematic diagram depicting a system framework for operating a method for image data augmentation and a method for training model using augmented image data according to one embodiment of the present disclosure;

FIG. 3 is a schematic diagram illustrating a process for augmenting data by cropping an original image into multiple image blocks with random sizes in one embodiment of the present disclosure;

FIG. 4 is a flowchart illustrating a method for image data augmentation based on randomly-cropped and resized image blocks according to one embodiment of the present disclosure;

FIG. 5 is a schematic diagram depicting that the data is augmented by randomly cropping and resizing an original image in another embodiment of the present disclosure;

FIG. 6 is a flowchart illustrating the method for image data augmentation based on randomly-cropped and resized image blocks in another embodiment of the present disclosure;

FIG. 7 is a flowchart illustrating a method for using augmented data to establish an intelligent model in one embodiment of the present disclosure; and

FIG. 8 is a schematic diagram depicting a system framework for performing a liveness detection method in one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

When proposing an artificial intelligence machine learning model to solve problems, collecting a large amount of data is necessary to establish a training set for training an intelligent model. In general, it relies on data diversity to train the intelligent model with generalization for reaching a high accuracy requirement.

With training a computer vision model as an example, performance of the computer vision models may be challenged in certain circumstances due to generalization problems if the data of its training set is limited to some specific circumstances or images in some types. Accordingly, the present disclosure provides a method for image data augmentation, a method for training model using augmented image data and a non-transitory computer-readable medium that stores instruction sets used to perform the method for image data augmentation and the method for training model using augmented image data. One of the objectives of the method for image data augmentation is to strengthen data diversity for obtaining augmented data to train an intelligent model and enable the intelligent model to improve generalization capability.

According to certain embodiments of the method for image data augmentation, one main technical concept is to perform an image data augmentation program in a computer system on the image data. The diversity of the image data in the training set can be strengthened by randomly cropping the image data by images and recombining the image blocks cropped from the image data.

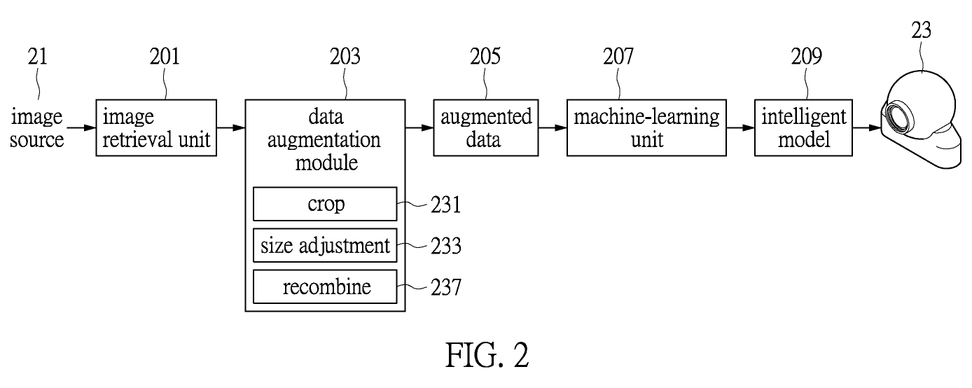

Reference is made to FIG. 2, which is a schematic diagram depicting a system framework that operates the method for image data augmentation and the method for a training model using augmented image data according to certain embodiments of the present disclosure.

Some functional components that are implemented through collaboration of hardware and software of a computer system shown in the diagram are such as an image retrieval unit 201, a data augmentation module 203 and a machine-learning unit 207 that are used to achieve purposes of data augmentation and model training. In a software process operated in the computer system, the image retrieval unit 201 is used to retrieve image data from an image source 21. The image source 21 can be a database or a platform that is provided for collecting image data. The image retrieval unit 201 performs preprocessing processes such as format conversion and data cleaning for filtering invalid data on the image data. The image retrieval unit 201 can also be used to label the features of the image data to form an initial training data. The data augmentation module 203 can then perform an image data augmentation procedure.

In certain embodiments of the present disclosure, the data augmentation module 203 performs image data augmentation image-by-image on the initial training data. A training set with data diversity can be formed of the augmented data with the initial training data. According to one embodiment of the present disclosure, the image data can be image-by-image cropped (231). For example, when original images with an aspect ratio of a length (H) and a width (W) are received, each of the original images is randomly cropped into a first size image with an aspect ratio of a length (H’) and a width (W’). The aspect ratio of the first size image can be different from the aspect ratio of the original image. It should be noted that, when a large amount of the original images is received, the original images can be image-by-image cropped in various aspect ratios. The first size image that is cropped from the original image may still include the content having recognizable image features.

The length (H’) and the width (W’) of the first size image can be resized respectively in different ratios to be a second size image with an aspect ratio of a length (H”) and a width (W”) through a function of size adjustment 233. Accordingly, multiple first size images can be image-by-image adjusted to be the second size images with different aspect ratios. The first size image can be adjusted to be the second size image with a larger image or a smaller image. The first size images are adjusted to be larger or smaller second size images, and the second size images can be uniformly resized to the images with a consistent size. It is proposed that the images undergoing normalization can facilitate subsequent machine learning processes.

Next, the second size images can be image-by-image cropped randomly at different positions to form multiple image blocks with random sizes. For example, a data augmentation procedure operated in the data augmentation module 203 is configured to crop the second size image to multiple image blocks in an array of “m×n” image blocks, in which “m” and “n” are the same integer or different integers greater than 1, to be recombined. A software process can be used to number the “m×n” image blocks that are arranged in an array sequentially. After randomly arranging the “m×n” image blocks, the randomly-arranged image blocks are then recombined in a recombine block 237 to obtain an augmented image. An augmented data 205 can be obtained by repeatedly operating the data augmentation module 203. Therefore, the multiple original images can be used to generate multiple augmented images that form a training set for a machine-learning unit 207. The machine-learning unit 207 performs a machine learning algorithm to learn correlations between the image features and data in the augmented data 205. Lastly, an intelligent model 209 used to conduct prediction and classification on objects in the images can be obtained. The intelligent model 209 can be applied to a specific terminal device 23, such as a camera device shown in the diagram. The camera device acts as an edge-computing device that operates the intelligent model 209 and conducts prediction and classification on the images in real time when the images are taken.

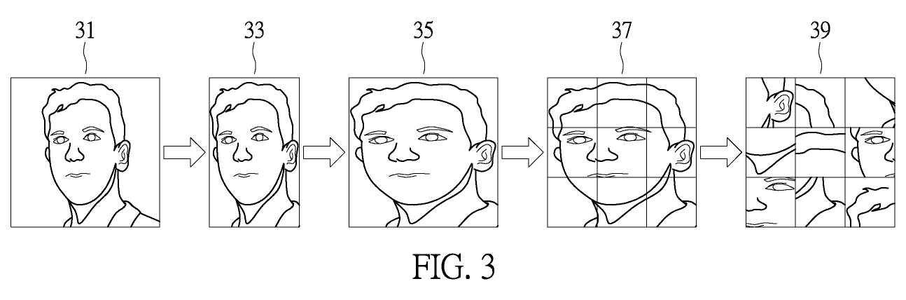

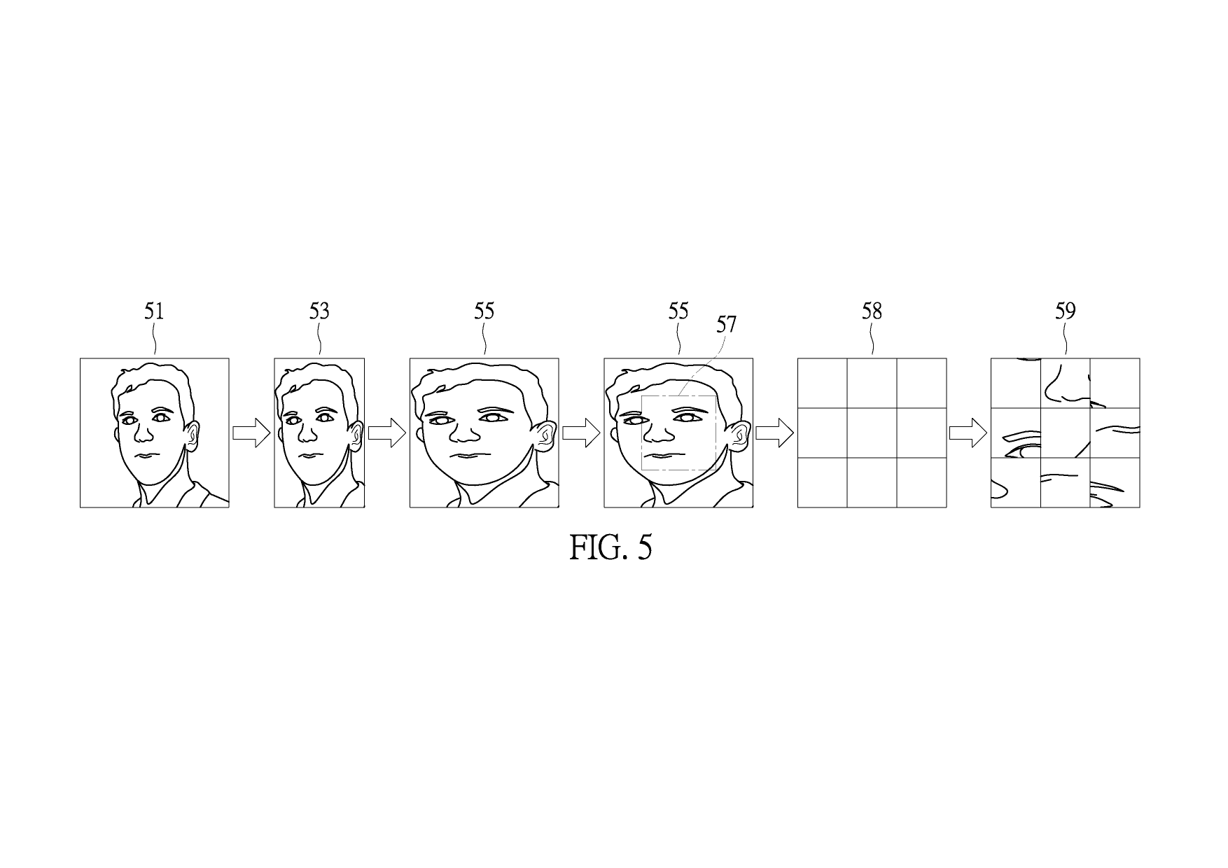

What follows is an exemplary example of generating a training set used to train a human-face recognition model. The method for generating the training set can also be adapted to training other biometric models. One of the technical concepts is to train a human face (or other biological features) recognition model. It is worth noting that the image data of the training set needs not use a complete facial image since it is not limited to any specific portion of the human face. Conversely, the human face recognition model that is trained by complete human facial images may be limited to some specific applications. As shown in FIGS. 3 and FIG. 5, the original facial image can be randomly cropped and resized multiple times to be multiple image blocks. The multiple image blocks are finally recombined to be augmented image data. The augmented image data includes various facial images formed by re-arranging the image blocks that include human facial features but are different from general perception of human facial images, by which the augmented image data can be generated when diversity of the image data is strengthened by destructing the facial images.

Further, feature labels can be assigned to the human facial images. The labels can be encoded to be vectors when training a model, and the labels are then processed by a label smoothing algorithm for preventing the conditions that the original hard labels in a model training process may easily cause the model to overly focus on details of the training data and lead to an overfitting phenomenon. The label smoothing algorithm is configured to generate soft labels by applying weighted averages between a uniform distribution and the hard labels. Therefore, the distribution of the labels can be smoothened. The image data generated through the soft labels can prevent the overfitting phenomenon when the model is trained, and generalization of the intelligent model can be strengthened.

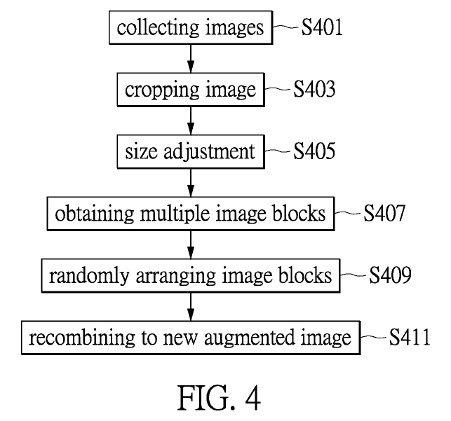

FIG. 3 is a schematic diagram depicting that the data can be augmented by randomly cropping and resizing an original image according to certain embodiments of the present disclosure. Reference is also made to FIG. 4, which is a flowchart illustrating the method for image data augmentation based on the image blocks that are formed by randomly cropping and resizing the original images according to one embodiment of the present disclosure.

For establishing the training set used to train the intelligent model, multiple images are firstly collected and each of the multiple images can be processed by a data augmentation procedure for a purpose of data augmentation. In FIG. 3, an original image 31 is obtained (step S401). Next, a data augmentation procedure is performed on the original image 31, by which the original image 31 can be cropped in a specific ratio to form a first size image 33 (step S403). The aspect ratio of the first size image 33 is configured to be different from the aspect ratio of the original image 31. It should be noted that, taking a human facial image as an example, the first size image 33 should retain the portion that can be used to identify the features of a human face. The cropping ratio can be randomly determined and the multiple images can be cropped in different ratios.

Next, the first size image 33 can be modified to be the second size image 35. For example, the original image 31 can be resized to the second size image 35 with the same aspect ratio (step S405). It should be noted that a length and a width of the first size image 33 can be respectively adjusted in different ratios, and an area of the first size image 33 with the adjusted aspect ratio can be further adjusted, so that the multiple second size images 35 can be generated in the data augmentation procedure. In one further embodiment of the present disclosure, for the first size image 33 that is adjusted, the aspect ratio of the first size image 33 can further be adjusted, and the first size image 33 can further be cropped into a smaller second size image 35, so that the multiple second size images 35 can still be generated in the data augmentation procedure.

The step of cropping the first size image 33 to the smaller second size image 35 can be randomly repeated to obtain multiple ones of the second size image 35 at different positions and with different sizes (step S407). In one of the embodiments of the present disclosure, the multiple second size images 35 that can be processed by size adjustment, if necessary, can be arranged in a “m×n” array to be multiple image blocks 37 with the same size or different sizes, in which “m” and “n" are a same integer or different integers greater than 1. The exemplary example shown in FIG. 3 depicts the multiple second size images 35 being arranged to be “3×3” image blocks. Next, the multiple image blocks 37 that can be sequentially numbered can be randomly shuffled (step S409) and then recombined to be new augmented images 39 (step S411). Thus, the multiple original images 31 can be used to generate the multiple augmented images 39 after repeatedly performing the above-described data augmentation procedure, so that a training set used for training the intelligent model can be formed.

It should be noted that, according to the exemplary flowchart of the method for image data augmentation described in FIG. 4, when the computer system receives the original images 33, the data augmentation procedure is performed on the original images 33 to form the multiple augmented images 39. The original images 33 can be mixed with the additional augmented images 39 so that the purpose of data augmentation can be achieved, and the related training set can strengthen generalization of the intelligent model being trained. Further, the data augmentation procedure also includes color jitter and blur processing that are configured to be performed on any of the augmented images 39, so that the augmented images 39 can be used to generate more image features to be learned. It is also noted that the image-processing technology of color jitter is used to add smaller and random perturbations into the augmented images 39 based on the image color values of the training set to emulate richer color variations thereof. Therefore, the diversity of the image data can be strengthened.

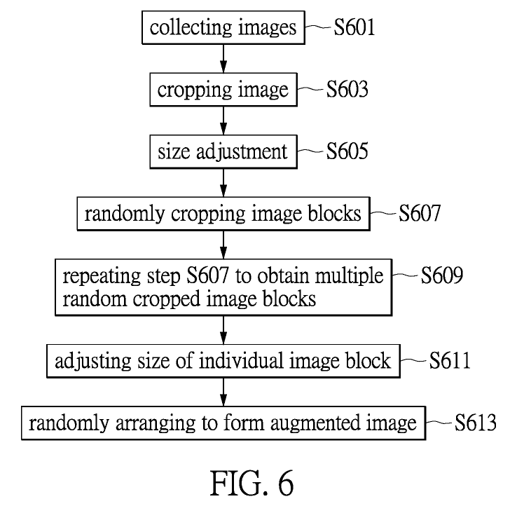

Reference is next made to FIG. 5, which is a schematic diagram depicting that the data can be augmented by randomly cropping and resizing an original image to be an image block according to one embodiment of the present disclosure, and FIG. 6, which is a flowchart illustrating a method for image data augmentation in one embodiment of the present disclosure can be referred to.

After images are collected (step S601), the data augmentation procedure is performed on the images. In the present embodiment, an original image 51 is cropped (step S603), and it should also be noted that the cropped image should retain the portion that can be used to identify the image features of the original image 51 to form a first size image 53.

Next, the aspect ratio of the first size image 53 can be adjusted (step S605). For example, the first size image 53 can be adjusted to have the same aspect ratio of the original image 51 to generate a second size image 55. In the present embodiment, by an image-processing technology, a region can be randomly selected from the second size image 55, including a randomly-determined size and a cropping position, and the region can then be cropped from the second size image 55 (step S607). An image block 57 is therefore obtained. After repeating the step S607 multiple times, multiple regions with different sizes and positions can be randomly selected from the second size image 55. Accordingly, the multiple image blocks 57 are obtained by cropping the selected regions (step S609).

After that, the sizes of the multiple image blocks that, in the step S609, by repeating the step S607 to randomly crop and resize the second size image 55 can be adjusted in compliance with an aspect ratio preset by the computer system (step S611). In one of the embodiments of the present disclosure, as shown in the diagram, multiple image blocks such as the preset block image 58 with multiple individual sizes can be obtained. For example, a cropping window that can be randomly moved and resized is configured to crop the second size image 55 multiple times to obtain multiple image blocks such as the image block 57. Next, multiple ones of the image block 57 with different sizes are respectively resized according to a predetermine size with a specific length and a specific width. The multiple resized image blocks can be randomly arranged to be a new augmented image 59 (step S613).

According to one of the embodiments of the present disclosure, in the step S611 for adjusting sizes of the multiple image blocks, the aspect ratio of each of the multiple image blocks can be referred to the size of each of the blocks of the block image 58 shown in FIG. 5. In a practical operation, the sizes of the image blocks that are cropped from the second size image 55 can be larger than each of the blocks of the block image 58. Further, it is worthing noting that the image features of some portions of different image blocks may be overlapped since the image blocks are obtained by randomly resizing and cropping. For example, a length of the image block can be between one to two times the length of each of the blocks of the block image 58, and a width of the image block can also be between one to two times the width of each of the blocks of the block image 58. Thus, the images forming the training set can be with variant sizes and also retain the features of details. Accordingly, the model trained by the training set can have a better accuracy.

Thus, the original images 51 are separately cropped and the aspect ratio of each of the cropped images is also adjusted. The each of the cropped and resized images can also be randomly cropped with a random size and a random position and the cropped image should still retain the requisite image features. Next, the sequence of multiple image blocks is randomly shuffled to obtain a new image having the image features different from the original image 51. Thus, when the multiple original images 51 are image-by-image combined with multiple augmented images 59 to form a dataset having image diversity. The generalization of the intelligent model trained with the dataset can be strengthened.

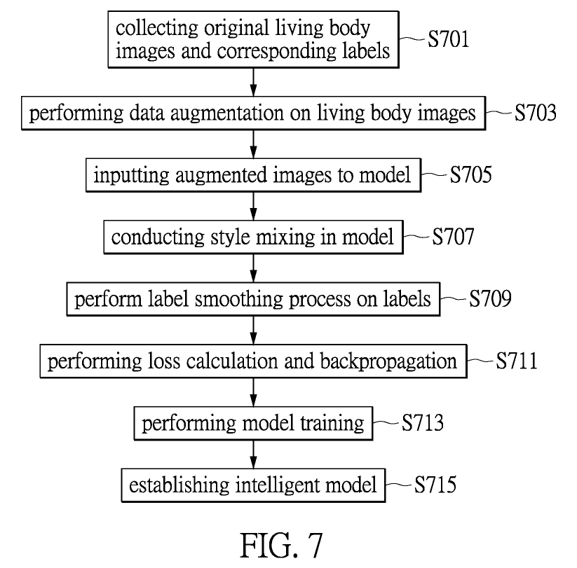

The above-described training set having the augmented image data, such as an augmented living body dataset, can be applied to a method for establishing a liveness detection model through the augmented data, as described in FIG. 7.

According to the embodiment of the method performed in a computer system, image data and corresponding labels are collected in the beginning (step S701). The image data and the labels are such as an original living body image and its corresponding labels. Next, a data augmentation procedure is performed on each of the multiple living body images (step S703). The data augmentation procedure exemplarily including color jitter and blur processing can be performed on part of the living body images. The multiple living body images are image-by-image cropped to be multiple first size images. The aspect ratio of the first size image may be different from the aspect ratio of the original living body image. Next, the first size images are image-by-image resized to be multiple second size images. For example, a length and a width of the first size image can be respectively adjusted in different ratios and an area of the adjusted first size image can also be adjusted to form the second size image. Each of the second size images can be cropped with a random position and a random size to obtain multiple image blocks respectively having the image features of the living body at different positions. Each of the image blocks may have reduplicate image features with another image block. The multiple image blocks can be randomly arranged and recombined to be an augmented living body image. Lastly, multiple augmented living body images can be obtained.

After that, the augmented data is inputted to an intelligent model (step S705). It should be noted that the intelligent model is trained by a deep-learning algorithm with a training set that is formed of the multiple augmented images. In one of the embodiments of the present disclosure, the intelligent model can be MobileNetV2 that is a convolutional neural network in a field of computer vision and is configured to perform image identification. An aspect of the intelligent model is to identify a living body (e.g., a live face) or a pseudo body (e.g., spoofed face) since the intelligent model is trained by inputting a large amount of living body image data. In an exemplary example, the intelligent model can be used in an access control system for identifying whether or not a human face in images is a real face.

Next, style mixing (MixStyle) can be performed on the augmented living body images in a biological test model (step S707). It should be noted that, when using the training set to train an intelligent model, the mix style can be applied to a middle layer of the intelligent model for processing feature-layer style mixing. The image data can be mixed with the augmented living body images in different ratios. Similarly, the data augmentation technology such as mixing and style transfer can be used to generate new image data, and the new image data can be trained in a convolutional neural network to form the intelligent model with generalization.

Afterwards, the labels being assigned to the original living body images and the augmented living body images are processed by a label smoothing process (step S709), so that the distribution of the labels can be smoothed through soft labels that are generated by applying weighted averages between a uniform distribution and the hard labels. Next, the method goes on to loss calculation and backpropagation (step S711). It should be noted that a loss function can be used to assess a prediction result and distances among the multiple labels of the intelligent model that is under a training process. The backpropagation algorithm can be used to calculate descent gradients of a multi-layer neural network, in which the gradients of the loss function can be calculated with variables that can be the weights of each of the layers of the neural network. Therefore, the loss function can be minimized by updating the multiple weight values of the intelligent model.

The weights of the model can be updated according to an error result calculated from the loss function and the model can be trained and optimized by continuously minimizing the loss function (step S713). When the model being trained reaches a predetermined training cycle and the loss function has been minimized, the training on the intelligent model such as the liveness detection model is completed (step S715).

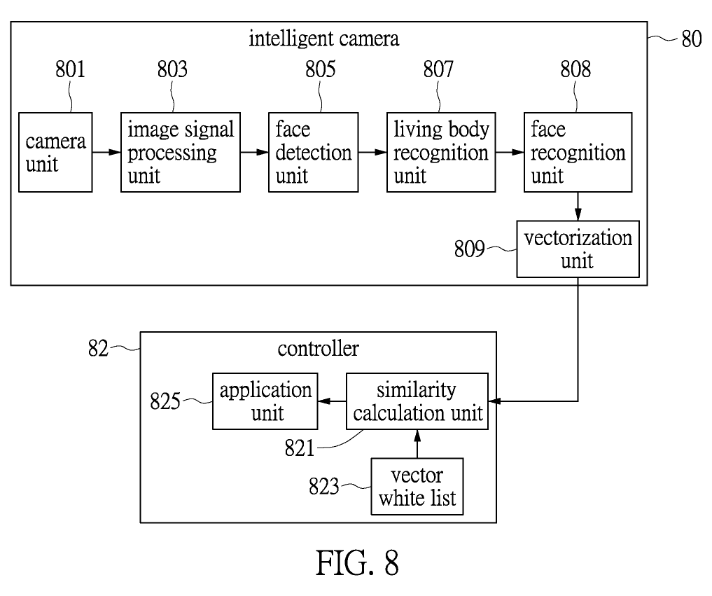

After that, the liveness detection model can be used to test a living body at an inference stage, by which the living body (e.g., a real human face) and a pseudo body (e.g., a human face on a picture) can be determined. In certain embodiments of the present disclosure, a system framework for operating a method for testing a living body can be referred to a schematic diagram shown in FIG. 8.

A system for operating the liveness detection model shown in FIG. 8 includes an intelligent camera 80 and a controller 82. The system can be used in an access control system that uses a human face or other biometrics to be a proof of identity. The system can particularly be used to detect authenticity of the human faces.

According to certain embodiments of the present disclosure, the controller 82 can be a computer system, a network platform or a computing device installed in a terminal device that implements functional components through collaboration of software and hardware. The intelligent camera 80 can implement its functions by a system on a chip (SoC). The intelligent camera 80 includes a camera unit 801 that is used to capture images. The image signals obtained by the camera unit 801 are such as the image signals of continuous frames and processed by an image signal processing unit 803. The image features can therefore be obtained. A face detection unit 805 then relies on the image features to detect a human face and determine whether any facial feature is included in the image.

After that, a living body detection unit 807 receives a facial image determined by the face detection unit 805. In one of the embodiments of the present disclosure, before the liveness detection model operated in the system determines the authenticity of any human face in the image, an initial processing can be firstly performed. The initial processing is such as cropping a portion having the facial features from a larger image and enhancing the image features by adjusting a brightness, a contrast, a saturation and/or a color temperature. The liveness detection model can then be used to calculate a probability that a real human face existing in the image is predicted. A probability threshold set by the system is referred to for determining whether any real human face exists in an image or whether it is a facial image in a picture. For example, a real human face is determined when the probability of predicting a real human face in the image is larger than the probability threshold. The image having the real human face can then be submitted to a face recognition unit 808 for identifying the human face. On the contrary, no real human face is detected if the probability of predicting the real human face in the image is not larger than the probability threshold.

After the image having the real human face is confirmed, the face recognition unit 808 is used to identify the human face and a vectorization unit 809 calculates embedding vectors of the facial image features. The facial embedding vectors that are image-by-image calculated from the images are transmitted to a similarity calculation unit 821 of the controller 82. The similarity calculation unit 821 is configured to compare the received embedding vectors with facial vectors registered in a vector white list 823 to confirm whether the captured human face is any of the human faces registered in the vector white list 823. In an access control system, an application unit 825 can deny access of a person or conduct any appropriate measure (e.g., sending messages or issuing an alarm) if the similarity calculation unit 821 determines that the captured human face is not in the vector white list 823. Otherwise, the application unit 825 can proceed with a following measure such as opening a door and sending a welcome message after confirming the identity of a person when the similarity calculation unit 821 determines that the captured human face has been registered in the vector white list 823.

The method for image data augmentation and the method for training model using augmented image data of the present disclosure are mainly performed by a computer system, and a non-transitory computer-readable medium is also provided. According to one embodiment of the present disclosure, an instruction set stored in the non-transitory computer-readable medium includes a first set of program codes and a second set of program codes. The first set of program codes are performed by one or more processors of the computer system for implementing the method for image data augmentation, in which, after multiple images are received, the data augmentation procedure is performed on each of the multiple images, as shown in the flowcharts described in FIGS. 4 or FIG. 6.

Further, the second set of program codes stored in the non-transitory computer-readable medium are performed by the one or more processors for implementing the method for training model using augmented image data, in which, the multiple augmented images obtained from the multiple images are received and a deep-learning algorithm is performed on the multiple augmented images to form a training set used to train an intelligent model.

In conclusion, according to the above embodiments of the present disclosure, the augmented data that is obtained by recombining the randomly-cropped and resized image blocks can form a training set with diverse image features and improve variability of a machine-learning algorithm, and the intelligent model trained by the training set will have a better robustness. Further, the intelligent model can be with high accuracy and generalization when the intelligent model passes various tests through many model effectiveness evaluation methods.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for image data augmentation, performed in a computer system, comprising:
receiving multiple images; and
respectively performing a data augmentation procedure on the multiple images, wherein the data augmentation procedure comprises:
randomly cropping any of the multiple images multiple times at different positions to form multiple image blocks with random sizes; and
adjusting a size of each of the multiple image blocks, randomly arranging the multiple image blocks, and recombining the multiple image blocks to be an augmented image;
wherein, after repeatedly performing the data augmentation procedure, multiple ones of the augmented image are generated from the multiple images to form a training set used to train an intelligent model.

2. The method according to claim 1, wherein each of the multiple images is cropped to be a first size image having an aspect ratio different from an original aspect ratio of each of the multiple images.

3. The method according to claim 2, wherein a length and a width of the first size image are respectively adjusted in different ratios, or an area of the first size image with a modified aspect ratio is further adjusted to form a second size image; wherein the multiple images are image-by-image adjusted to be multiple ones of the second size image used for the data augmentation procedure.

4. The method according to claim 2, wherein a length and a width of the first size image are adjusted in different ratios or an area of the first sizes image with an adjusted aspect ratio is further adjusted, and the first size image with the adjusted aspect ratio is further cropped to a smaller second size image, by which the multiple images are image-by-image adjusted and cropped to be multiple ones of the second size image in the data augmentation procedure.

5. The method according to claim 1, wherein the data augmentation procedure further includes performing color jitter and blur processing on any of the multiple images.

6. The method according to claim 1, wherein the augmented images are formed by recombining the multiple image blocks that are randomly cropped in a "m×n" array, in which "m" and "n" are a same integer or different integers greater than 1.

7. The method according to claim 6, wherein, in the data augmentation procedure, any of the multiple images is randomly cropped at different positions multiple times to obtain the multiple image blocks with random sizes.

8. A method for training model using augmented image data, performed in a computer system, comprising:
retrieving multiple images, and respectively performing a data augmentation procedure on the multiple images, wherein any of the multiple images is randomly cropped multiple times at different positions to form multiple image blocks with random sizes; after a size of each of the multiple image blocks is adjusted, the multiple image blocks are randomly arranged and recombined to form an augmented image, and multiple ones of the augmented image are generated from the multiple images; and
performing a deep-learning algorithm for training an intelligent model by a training set that is formed by the multiple augmented images.

9. The method according to claim 8, wherein, in the data augmentation procedure, each of the multiple images is cropped to be a first size image having an aspect ratio different from an original aspect ratio of each of the multiple images.

10. The method according to claim 9, wherein a length and a width of the first size image are adjusted in different ratios, or an area of the first size image with an adjusted aspect ratio is further adjusted to form a second size image, by which the multiple images are image-by-image adjusted and cropped in the data augmentation procedure to form multiple ones of the second size image.

11. The method according to claim 9, wherein a length and a width of the first size image are adjusted in different ratios or an area of the first sizes image with an adjusted aspect ratio is further adjusted, and the first size image with the adjusted aspect ratio is further cropped to a smaller second size image, by which the multiple images are image-by-image adjusted and cropped to be multiple ones of the second size image in the data augmentation procedure.

12. The method according to claim 8, wherein, in the data augmentation procedure, the augmented images are formed by recombining the multiple image blocks that are randomly cropped in a "m×n" array, in which "m" and "n" are a same integer or different integers greater than 1.

13. The method according to claim 12, wherein, in the data augmentation procedure, any of the multiple images is randomly cropped at different positions multiple times to obtain the multiple image blocks with random sizes.

14. The method according to claim 8, wherein the multiple images are multiple human facial images.

15. The method according to claim 14, wherein the intelligent model that is trained by the multiple augmented images is used to identify a live face or a spoofed face through multiple human facial images.

16. The method according to claim 8, wherein, when using the training set to train the intelligent model, a mix style is applied to a middle layer of the intelligent model for processing feature-layer style mixing.

17. The method according to claim 16, wherein multiple labels are assigned to the multiple augmented images based on image features of the augmented images that are generated by repeating the data augmentation procedure, and the multiple labels are processed by a label smoothing process.

18. The method according to claim 17, wherein a loss function is used to evaluate a prediction result and distances among the multiple labels of the intelligent model that is under a training process, and a backpropagation algorithm is used to calculate gradients of the loss function, in which the loss function is minimized by updating multiple weight values of the intelligent model.

19. A non-transitory computer-readable medium, which is used to store an instruction set including a first set of program codes to be performed by one or more processors of a computer system to implement a method for image data augmentation, wherein the method comprises:
receiving multiple images; and
respectively performing a data augmentation procedure on the multiple images, wherein the data augmentation procedure comprises:
randomly cropping any of the multiple images multiple times at different positions to form multiple image blocks with random sizes; and
adjusting a size of each of the multiple image blocks, randomly arranging the multiple image blocks, and recombining the multiple image blocks to be an augmented image;
wherein, after repeatedly performing the data augmentation procedure, multiple ones of the augmented image are generated from the multiple images to form a training set used to train an intelligent model.

20. The non-transitory computer-readable medium according to claim 19, wherein the instruction set further comprises a second set of program codes that are performed by the one or more processors to implement a method for training model using augmented image data, comprising:
obtaining the multiple augmented images generated from the multiple images; and
performing a deep-learning algorithm for training the intelligent model by the training set formed of the multiple augmented images.
